(19) United States
(12) Patent Application Publication
(10) Pub. No.: US 2025/0284150 A1
(43) Pub. Date: Sep. 11, 2025

(54) OPTICAL PHASE SHIFTER

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventors: Taku SUZUKI, Nisshin-shi (JP); Masashige SATO, Nisshin-shi (JP); Koichi OYAMA, Nisshin-shi (JP)

(21) Appl. No.: 19/037,412

(22) Filed: Jan. 27, 2025

(30) Foreign Application Priority Data
Mar. 6, 2024 (JP) 2024-034000

(51) Int. Cl. G02F 1/025

(52) U.S. Cl. CPC G02F 1/025; G02F 2201/063

(57) ABSTRACT

An optical phase shifter includes a core portion and a slab portion. The core portion has a first convex portion of a first conductivity type and a second convex portion of a second conductivity type. The slab portion has a first slab portion of a first conductivity type and a second slab portion of a second conductivity type. The first slab portion is electrically connected to the first convex portion, and the second slab portion is electrically connected to the second convex portion. Within a predetermined region where a PN junction is formed between the slab portion and the core portion, the second convex portion is arranged on both sides of the core portion adjacent to the slab portion, and the first slab portion is arranged on sides of the core portion.

### CROSS REFERENCE TO RELATED APPLICATION

This application is based on Japanese Patent Application No. 2024-034000 filed on Mar. 6, 2024, the disclosure of which is incorporated herein by reference.

### TECHNICAL FIELD

The present disclosure relates to an optical phase shifter.

### BACKGROUND

An optical phase shifter has a PN junction. Specifically, the optical phase shifter has a waveguide that extends in one direction as extension direction. The waveguide includes a core portion through which light propagates. The core portion is interposed between a first slab portion and a second slab portion, each of which having a thickness thinner than that of the core portion.

### SUMMARY

According to one aspect of the present disclosure, an optical phase shifter includes: a core portion extending in an extending direction and having a thickness direction intersecting with the extending direction; and a slab portion arranged on sides of the core portion. A length of the slab portion in the thickness direction is shorter than that of the core portion. The core portion has a first convex portion of a first conductivity type and a second convex portion of a second conductivity type. The slab portion has a first slab portion of a first conductivity type and a second slab portion of a second conductivity type. The first slab portion is electrically connected to the first convex portion, and the second slab portion is electrically connected to the second convex portion. The first convex portion and the second convex portion are arranged to form a PN junction. The slab portion is made of an ion implantation layer, and is located to include a portion that forms the PN junction with the core portion, the PN junction being formed between the slab portion and the core portion within a predetermined region. The second convex portion is arranged on both sides of the core portion adjacent to the slab portion within the predetermined region. The first slab portion is arranged on sides of the core portion within the predetermined region.

### BRIEF DESCRIPTION OF DRAWING

FIG. 1 is a plan view of an optical phase shifter according to a first embodiment.

FIG. 2 is a cross-sectional view taken along line II-II in FIG. 1.

FIG. 3 is a cross-sectional view taken along line III-III in FIG. 1.

FIG. 4 is a cross-sectional view taken along line IV-IV in FIG. 1.

FIG. 5 is a schematic diagram showing positions of a first slab portion and a second slab portion when misalignment occurs in an optical phase shifter of a comparative example and the optical phase shifter of the first embodiment.

FIG. 6 is a diagram showing a relationship between a change in the amount of phase modulation and a misalignment of the first slab portion and the second slab portion.

FIG. 7 is a plan view of an optical phase shifter according to a modification of the first embodiment.

FIG. 8 is a plan view of an optical phase shifter according to a second embodiment.

FIG. 9 is a plan view of an optical phase shifter according to a third embodiment.

FIG. 10 is a cross-sectional view taken along line X-X in FIG. 9.

FIG. 11 is a cross-sectional view taken along line XI-XI in FIG. 9.

FIG. 12 is a cross-sectional view taken along line XII-XII in FIG. 9.

FIG. 13 is a cross-sectional view taken along line XIII-XIII in FIG. 9.

### DETAILED DESCRIPTION

An optical phase shifter has a PN junction. Specifically, the optical phase shifter has a waveguide that extends in one direction as extension direction. The waveguide includes a core portion through which light propagates, and a first slab portion and a second slab portion between which the core portion is arranged. Each of the first slab portion and the second slab portion has a thickness thinner than that of the core portion.

More specifically, the core portion has an N-type first convex portion and a P-type second convex portion. The first convex portion has a generally L-shape in a plan view, formed of an extension portion extending along the extension direction, and a lateral portion extending from an end of the extension portion along a lateral direction that crosses the extension direction. The second convex portion has a generally L-shape in a plan view, formed of an extension portion extending along the extension direction, and a lateral portion extending from an end of the extension portion along a lateral direction that crosses the extension direction. In the core portion, the first convex portion and the second convex portion, each of which being the generally L-shape, are fitted together. Specifically, the extension portion of the first convex portion and the extension portion of the second convex portion are adjacent to each other. The lateral portion of the first convex portion is connected to the extension portion of the second convex portion, and the lateral portion of the second convex portion is connected to the extension portion of the first convex portion.

The first slab portion is of an N+ type having a higher impurity concentration than the N-type of the core portion. The first slab portion is arranged on the opposite side of the extension portion of the first convex portion through the extension portion of the first convex portion, and is connected to the extension portion of the second convex portion and the lateral portion of the first convex portion. The second slab portion is of a P+ type having a higher impurity concentration than the P-type of the core portion. The second slab portion is arranged on the opposite side of the extension portion of the second convex portion through the extension portion of the first convex portion, and is connected to the extension portion of the first convex portion and the lateral portion of the second convex portion.

In the optical phase shifter, the core portion, the first slab portion, and the second slab portion are ion-implanted layers formed by ion implantation.

In the optical phase shifter as described above, there is a possibility that the first slab portion and the second slab portion may be misaligned in the lateral direction with respect to the core portion due to a mask misalignment or the like during ion implantation. If the first slab portion and the second slab portion are misaligned in the lateral direction, there is a possibility that the change in the optical modulation efficiency will become large.

The present disclosure provides an optical phase shifter capable of reducing changes in modulation efficiency.

According to one aspect of the present disclosure, an optical phase shifter includes a core portion extending in one direction as extension direction, and a slab portion disposed at sides of the core portion. The slab portion has a thickness in a thickness direction intersecting the extension direction, and the thickness of the slab portion is shorter than that of the core portion. The core portion has a first convex portion of a first conductivity type and a second convex portion of a second conductivity type. The first convex portion and the second convex portion are disposed in a state of forming a PN junction. The slab portion is configured by an ion implantation layer. The slab portion has a first slab portion of a first conductivity type and is electrically connected to the first convex portion, and a second slab portion of a second conductivity type and is electrically connected to the second convex portion. The slab portion is arranged to include a portion which forms a PN junction with the core portion. Within a predetermined region where the PN junction is formed between the slab portion and the core portion, the second convex portions are arranged on both sides of the core portion adjacent to the slab portion, and the core portion is interposed between the first slab portions.

Accordingly, the core portion is interposed between the first slab portions within the predetermined region where the PN junction is formed between the core portion and the slab portion. Therefore, even if the first slab portion and the second slab portion are misaligned in the lateral direction intersecting the extension direction and the thickness direction, this misalignment can be easily offset. Therefore, it is possible to suppress a large change in the modulation efficiency.

Hereinafter, embodiments of the present disclosure will be described with reference to the drawings. In the following embodiments, the same or equivalent parts are denoted by the same reference numerals.

### First Embodiment

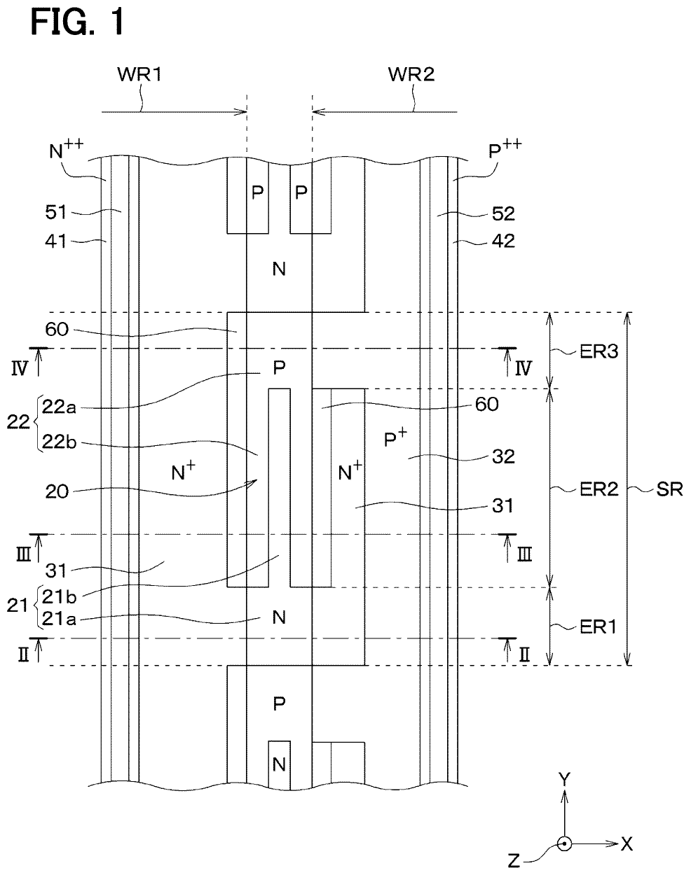

An optical phase shifter of the first embodiment will be described with reference to FIGS. 1 to 4. The optical phase shifter of this embodiment is suitable for use in, for example, optical fiber communication devices.

The optical phase shifter of this embodiment includes a semiconductor substrate 10 made of a Silicon On Insulator (SOI) substrate in which a support substrate 11, an insulating layer 12, and an active layer 13 are stacked. In this embodiment, the support substrate 11 is made of silicon or the like. The insulating layer 12 is made of an oxide film or the like, and the active layer 13 is made of silicon or the like.

Hereinafter, one direction in the surface direction of the semiconductor substrate 10 will be referred to as X direction. A direction perpendicular to the X direction and along the surface direction of the semiconductor substrate 10 will be referred to as Y direction. A direction perpendicular to the X direction and the Y direction will be referred to as Z direction. In FIG. 1, the left-right direction on the paper surface is the X direction. The up-down direction on the paper surface is the Y direction, and a direction perpendicular to the paper surface is the Z direction. The Z direction is defined along a normal to the surface direction of the semiconductor substrate 10, and can also be said to be a thickness direction of the semiconductor substrate 10. Furthermore, the Z direction is defined along the stacking direction of the support substrate 11, the insulating layer 12, and the active layer 13. In the following description, the X direction is also referred to the width direction. The length in the X direction is simply referred to as the width, and the length in the Z direction is simply referred to as the thickness.

The active layer 13 includes a core portion 20 doped with impurities, a first slab portion 31, a second slab portion 32, a first contact portion 41, a second contact portion 42, and the like so as to form a waveguide. The core portion 20, the first slab portion 31, the second slab portion 32, the first contact portion 41, and the second contact portion 42 are formed of ion-implanted layers into which impurity ions are implanted. Moreover, the active layer 13 of this embodiment includes a non-doped layer 60 that is not doped with impurities. Furthermore, the active layer 13 is provided with a first electrode portion 51, a second electrode portion 52, and the like, as described below.

The core portion 20 extends along the Y direction in the surface direction of the semiconductor substrate 10, and has an N-type first convex portion 21 and a P-type second convex portion 22. In this embodiment, the first convex portion 21 and the second convex portion 22 have approximately the same impurity concentration. In this embodiment, the Y direction corresponds to an extending direction of the core portion 20, and light propagates along the Y direction.

The first convex portion 21 has an approximately T-shape formed by a width portion 21a having the same width as the width of the core portion 20, and an extension portion 21b extending in the Y direction from approximately the center of the width portion 21a in the X direction. The second convex portion 22 has an approximately U-shape formed by a width portion 22a having the same width as the width of the core portion 20, and an extension portion 22b extending in the Y direction from both ends of the width portion 22a in the X direction.

The core portion 20 is configured so that the first convex portion 21 and the second convex portion 22 are fitted together. Specifically, the first convex portion 21 and the second convex portion 22 are fitted together such that the extension portion 21b of the first convex portion 21 is interposed between the extension portions 22b of the second convex portion 22. In the core portion 20, the P-type, the N-type, and the P-type are arranged in this order in the X direction within an area where the extension portion 21b is interposed between the extension portions 22b. That is, both ends of the core portion 20 in the X direction are the P-type in the area where the extension portion 21b of the first convex portion 21 is interposed between the extension portions 22b of the second convex portion 22.

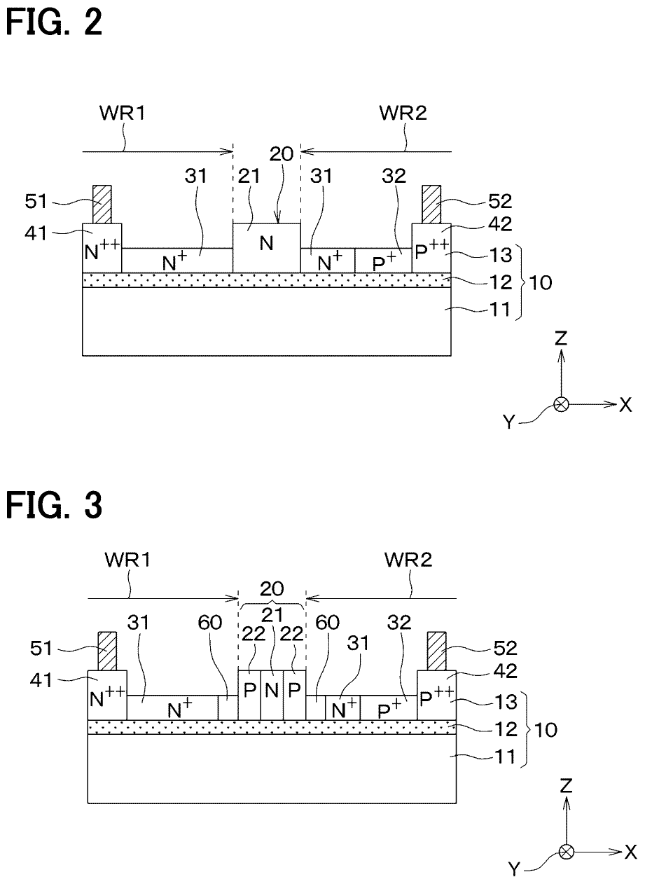

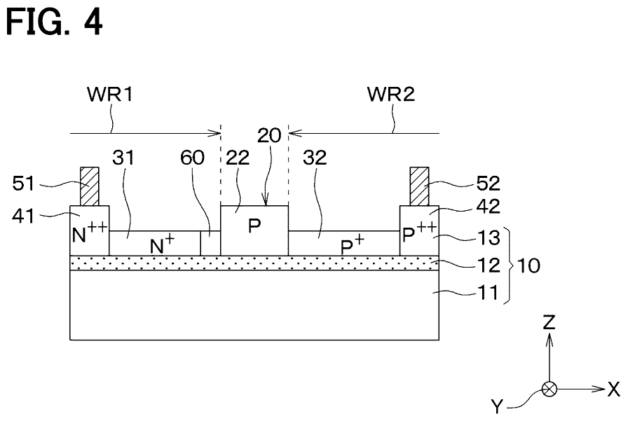

In this embodiment, a region where one first convex portion 21 and one second convex portion 22 are fitted together is referred to as one cell region SR. The cell region SR also includes the first slab portion 31 and the second slab portion 32 located adjacent to the first convex portion 21 and the second convex portion 22 fitted together in the X direction. The optical phase shifter is configured by repeatedly arranging the cell regions SR in the Y direction. In this embodiment, a region where only the first convex portion 21 is arranged as the core portion 20 in the X direction is described as a first extension region ER1. A region where the first convex portion 21 and the second convex portion 22 are arranged as the core portion 20 is described as a second extension region ER2. A region where only the second convex portion 22 is arranged as the core portion 20 is described as a third extension region ER3. In FIG. 1, the cell region SR is divided into the first extension region ER1, the second extension region ER2, and a third extension region ER3 from the bottom side of FIG. 1. FIG. 2 is a cross-sectional view of the first extension region ER1. FIG. 3 is a cross-sectional view of the second extension region ER2. FIG. 4 is a cross-sectional view of the third extension region ER3. A region located on one side of the core portion 20 in the X direction will be described as a first width region WR1, and a region located on the other side of the core portion 20 in the X direction will be described as a second width region WR2. In FIG. 1, a portion located to the left of the core portion 20 on the paper surface is the first width region WR1, and a portion located to the right of the core portion 20 on the paper surface is the second width region WR2.

The first slab portion 31 and the second slab portion 32 are thinner than the core portion 20. Therefore, the first slab portion 31 and the second slab portion 32 can also be said to form a recess for the waveguide.

The first slab portion 31 is of N+ type and has a higher impurity concentration than the first convex portion 21 of the core portion 20. In the first extension region ER1, the first slab portion 31 is arranged in the first width region WR1 and the second width region WR2 with the core portion 20 interposed therebetween, and is connected to the width portion 21a in the core portion 20.

In the second extension region ER2, the first slab portion 31 is arranged in the first width region WR1 and the second width region WR2 with the core portion 20 interposed therebetween. That is, in the second extension region ER2, the core portion 20 is interposed between the first slab portions 31 of a conductivity type (i.e., N-type) different from the conductivity type (i.e., P-type) of both ends in the X direction. In other words, in the second extension region ER2, the N-type first slab portion 31 is arranged to form a PN junction with each of the extension portions 22b (i.e., the P-type layer) arranged on both ends in the X direction of the core portion 20. However, in this embodiment, taking into consideration mask misalignment when forming the first slab portion 31 etc. by ion implantation, the non-doped layer 60 is interposed between the first slab portion 31 and the core portion 20 within the second extension region ER2.

In the third extension region ER3, the first slab portion 31 is disposed in the first width region WR1 to form a PN junction with the width portion 22a. However, in this embodiment, taking into consideration mask misalignment when forming the first slab portion 31 etc. by ion implantation, the non-doped layer 60 is interposed between the first slab portion 31 and the core portion 20 within the third extension region ER3.

The first slab portion 31 extends along the Y direction in the first width region WR1. The first slab portions 31 formed in the first extension region ER1, the second extension region ER2, and the third extension region ER3 are coupled and electrically connected with each other. In addition, the first slab portion 31 formed in the first extension region ER1 and the second extension region ER2 of the second width region WR2 is electrically connected to the first slab portion 31 formed in the first width region WR1 via the width portion 21a of the first convex portion 21.

The second slab portion 32 is of P+ type having a higher impurity concentration than the second convex portion 22 of the core portion 20, and is disposed in the second width region WR2. More specifically, in the first extension region ER1 and the second extension region ER2, the second slab portion 32 is disposed opposite to the core portion 20 through the first slab portion 31. The second slab portion 32 is disposed in the third extension region ER3 so as to be connected to the width portion 22a of the second convex portion 22 in the core portion 20.

The second slab portion 32 formed in the second width region WR2 extends along the Y direction. The second slab portions 32 formed in the first extension region ER1, the second extension region ER2, and the third extension region ER3 are coupled and electrically connected with each other.

The first contact portion 41 is of N++ type, with an impurity concentration higher than that of the first slab portion 31. The first contact portion 41 extends along the Y direction in the first width region WR1. The first contact portion 41 is positioned opposite to the core portion 20 through the first slab portion 31, and is connected to the first slab portion 31.

The second contact portion 42 is of P++ type, with an impurity concentration higher than that of the second slab portion 32. The second contact portion 42 extends along the Y direction in the second width region WR2. The second contact portion 42 is positioned opposite to the core portion 20 through the second slab portion 32, and is connected to the second slab portion 32.

In this embodiment, the first contact portion 41 and the second contact portion 42 have the same thickness as the core portion 20.

The first electrode portion 51 is disposed on the first contact portion 41 and electrically connected to the first contact portion 41. The first electrode portion 51 extends along the Y direction in the same manner as the first contact portion 41. The second electrode portion 52 is disposed on the second contact portion 42 and electrically connected to the second contact portion 42. The second electrode portion 52 extends along the Y direction in the same manner as the second contact portion 42.

The above is the basic configuration of the optical phase shifter in this embodiment. In the present embodiment, the N-type corresponds to a first conductivity type, and the P-type corresponds to a second conductivity type. Next, the operation and effects of the optical phase shifter will be described.

In the optical phase shifter of this embodiment, in the second extension region ER2, the PN junction is formed between the extension portion 22b of the second convex portion 22 and the first slab portion 31 in the first width region WR1, and between the extension portion 22b of the second convex portion 22 and the first slab portion 31 in the second width region WR2. In the second extension region ER2, the PN junction is formed between the extension portion 21b of the first convex portion 21 and each of the two extension portions 22b of the second convex portion 22. In the third extension region ER3, the PN junction is formed between the width portion 22a of the second convex portion 22 and the first slab portion 31 of the first width region WR1.

In the optical phase shifter, light propagates along the extension direction of the core portion 20 (that is, the Y direction). At this time, a higher voltage is applied to the first contact portion 41 than to the second contact portion 42, so that a depletion layer expands at each of the PN junctions, and the carrier density decreases, thereby modulating the phase of the light. Hereinafter, application of a higher voltage to the first contact portion 41 than to the second contact portion 42 (i.e., application of a higher voltage to the first convex portion 21 than to the second convex portion 22) will be simply referred to as application of a reverse bias voltage.

The optical phase shifter of this embodiment is manufactured as follows.

First, the semiconductor substrate 10, which is an SOI substrate, is prepared. Next, etching is performed using a mask to thin portions of the active layer 13 to be the first slab portion 31 and the second slab portion 32. Then, N-type impurities and P-type impurities are appropriately ion-implanted using a mask to form the core portion 20 having the first convex portion 21 and the second convex portion 22. Next, N-type impurities and P-type impurities are appropriately ion-implanted to form the first slab portion 31 and the second slab portion 32.

Thereafter, N-type impurities and P-type impurities are appropriately ion-implanted to form the first contact portion 41 and the second contact portion 42. Further, the first electrode portion 51 and the second electrode portion 52 are appropriately formed to manufacture the optical phase shifter.

When forming the first slab portion 31 and the second slab portion 32, there is a possibility that the first slab portion 31 and the second slab portion 32 may be misaligned in the X direction due to a mask misalignment or the like. However, in this embodiment, since the optical phase shifter is configured as described above, even if the first slab portion 31 and the second slab portion 32 are misaligned in the X direction, the misalignment can be easily offset in the second extension region ER2, thereby restricting a large change in the modulation efficiency.

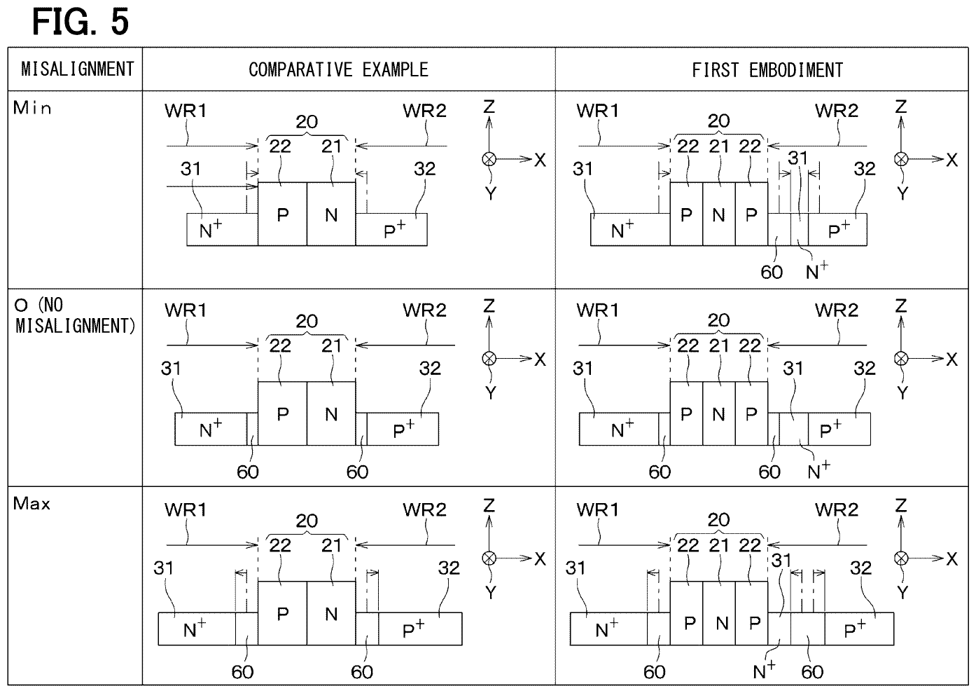

The change in modulation efficiency will be described in detail below in comparison with an optical phase shifter of a comparative example. In the following, the optical phase shifter of the comparative example shown in FIG. 5 will be described as examples of the comparative optical phase shifter. The cross-sectional view of the optical phase shifter in FIG. 5 shows a portion corresponding to the second extension region ER2 of this embodiment. In FIG. 5, the support substrate 11, the insulating layer 12, and the like are omitted in the optical phase shifter of the comparative example and the optical phase shifter of this embodiment.

First, in the optical phase shifter of the comparative example, as shown in FIG. 5, a core portion 20 has an N-type first convex portion 21 and a P-type second convex portion 22 arranged side by side in the X direction. In the comparative example, a P+ type second slab portion 32 is arranged opposite to the second convex portion 22 through the first convex portion 21, and an N+ type first slab portion 31 is arranged opposite to the first convex portion 21 through the second convex portion 22. In the comparative example, in a cross-section different from that of FIG. 5, the first convex portion 21 and the first slab portion 31 are electrically connected, and the second convex portion 22 and the second slab portion 32 are electrically connected.

FIG. 5 illustrates a no misalignment case in which the non-doped layer 60 having a desired width is disposed between the core portion 20 and the first slab portion 31 and between the core portion 20 and the second slab portion 32.

In FIG. 5, in the comparative example, the misalignment is Min when the first slab portion 31 and the second slab portion 32 are misaligned by the width of the non-doped layer 60 toward the core portion 20, in case where the misalignment is zero is taken as a reference. That is, in the comparative example, a positional misalignment in which the first slab portion 31 is in contact with the second convex portion 22 and the second slab portion 32 is in contact with the first convex portion 21 is shown as misalignment Min. In FIG. 5, in the case of misalignment Min, the first slab portion 31 is misaligned to the right side, and the second slab portion 32 is misaligned to the left side, in the optical phase shifter of the comparative example. According to the first embodiment, the first slab portion 31 and the second slab portion 32 are misaligned in the same direction as the first slab portion 31 and the second slab portion 32 of the comparative example, as the misalignment Min. In this case, in the present embodiment, the first slab portion 31 is shifted to the right side and the second slab portion 32 is shifted to the left side.

In FIG. 5, in the comparative example, when the misalignment is zero is taken as the reference, the case where the first slab portion 31 and the second slab portion 32 are misaligned by the width of the non-doped layer 60 away from the core portion 20 is shown as misalignment Max. In FIG. 5, the misalignment Max refers to the case where the first slab portion 31 is misaligned to the left side and the second slab portion 32 is misaligned to the right side in the comparative example. In the first embodiment, the misalignment Max is defined as the case where the first slab portion 31 and the second slab portion 32 are misaligned in the same direction as the case where the first slab portion 31 and the second slab portion 32 of the comparative example are misaligned. That is, in the optical phase shifter of this embodiment, the case where the first slab portion 31 is shifted to the left side and the second slab portion 32 is shifted to the right side is shown as the misalignment Max.

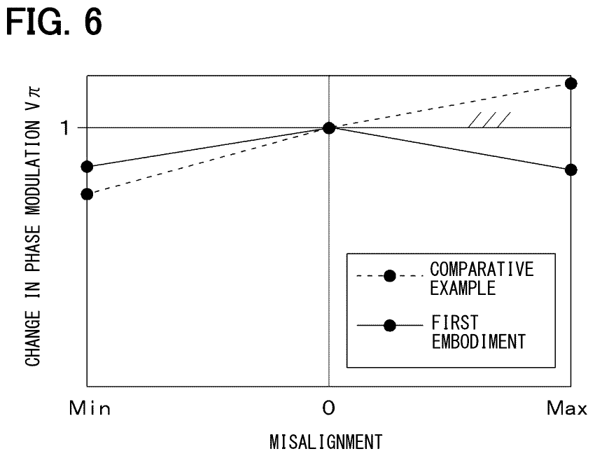

The inventors then conducted extensive research into a phase modulation amount V_{TT} when misalignment occurs as shown in FIG. 5 for the optical phase shifter of the comparative example and the optical phase shifter of this embodiment, and obtained the results shown in FIG. 6.

As shown in FIG. 6, if the phase modulation amount V_{TT} when the misalignment is zero is taken as the reference (i.e., the change in phase modulation amount V_{TT} is 1), it is confirmed that in the optical phase shifter of the comparative example, the phase modulation amount V_{TT} changes significantly due to misalignment. The phase modulation amount V_{TT} corresponds to an applied voltage required to change the phase of light by 180°, and it is preferable that the phase modulation amount V_{TT} to be smaller.

In the comparative example, when the misalignment is at Min, since the first slab portion 31 and the second slab portion 32 are close to the core portion 20, it is confirmed that the phase modulation amount V_{TT} is smaller than the reference value. However, in the comparative example, when the misalignment is at Max, it is confirmed that the phase modulation amount V_{TT} becomes larger than the reference value. That is, it is confirmed that, in the comparative example, the phase modulation amount V_{TT} changes greatly between when the misalignment is at Min and when the misalignment is at Max.

In contrast, in the optical phase shifter of this embodiment, the core portion 20 is interposed between the first slab portions 31 of the same conductivity type. For this reason, in this embodiment, as shown in FIG. 5, when the misalignment is Min, the first slab portion 31 in the first width region WR1 is misaligned toward the core portion 20, while the first slab portion 31 in the second width region WR2 is misaligned away from the core portion 20. Therefore, the misalignment of the first slab portion 31 in the first width region WR1 and the misalignment of the first slab portion 31 in the second width region WR2 are offset.

Similarly, when the misalignment is Max, the first slab portion 31 in the first width region WR1 is misaligned away from the core portion 20, while the first slab portion 31 in the second width region WR2 is misaligned toward the core portion 20. Therefore, the misalignment of the first slab portion 31 in the first width region WR1 and the misalignment of the first slab portion 31 in the second width region WR2 are offset.

Therefore, in the optical phase shifter of this embodiment, the phase modulation amount V_{TT} changes to the smaller side when the misalignment occurs to any side in the X direction. Therefore, in this embodiment, as shown in FIG. 6, a large change in the phase modulation amount V_{TT} due to misalignment is suppressed.

In the optical phase shifter of this embodiment, when the misalignment is at Min, in the second width region WR2, the misalignment is reversed between the first slab portion 31 and the second slab portion 32, and the width of the first slab portion 31 or the second slab portion 32 becomes shorter. Similarly, when the misalignment is at Max, in the second width region WR2, the misalignment is reversed between the first slab portion 31 and the second slab portion 32, and the non-doped layer 60 is formed between the first slab portion 31 and the second slab portion 32. However, there is no significant effect on the modulation efficiency even if the configuration is changed slightly since these portions do not mainly contribute to the light propagation.

Furthermore, in the optical phase shifter of this embodiment, the impurity concentration of the first slab portion 31 is made higher than the impurity concentration of the first convex portion 21. Therefore, if misalignment causes the first slab portion 31 to reach the inside of the core portion 20, the loss of light becomes large. Therefore, in the first slab portion 31, it is preferable that the width of the non-doped layer 60 is adjusted not to reach the inside of the core portion 20 even if misalignment occurs.

According to the present embodiment, in the second extension region ER2 where a PN junction is formed between the core portion 20 and the slab portion 31, 32, the core portion 20 is interposed between the first slab portions 31. Therefore, even if the first slab portion 31 and the second slab portion 32 are misaligned in the X direction, this misalignment can be easily offset, making it possible to suppress a large change in modulation efficiency.

(1) In this embodiment, in the second extension region ER2, the core portion 20 has the first convex portion 21 interposed between the second convex portions 22 in the X direction, and a PN junction is formed between the first convex portion 21 and the second convex portion 22. This makes it possible to increase the number of PN junctions and improve the modulation efficiency.

(2) In this embodiment, the core portion 20, the first slab portion 31, and the second slab portion 32 are repeatedly provided in the Y direction. That is, in this embodiment, the cell regions SR are repeatedly provided in the Y direction. This makes it easier to spread the depletion layer uniformly within the core portion 20, thereby improving the modulation efficiency.

### Modification of First Embodiment

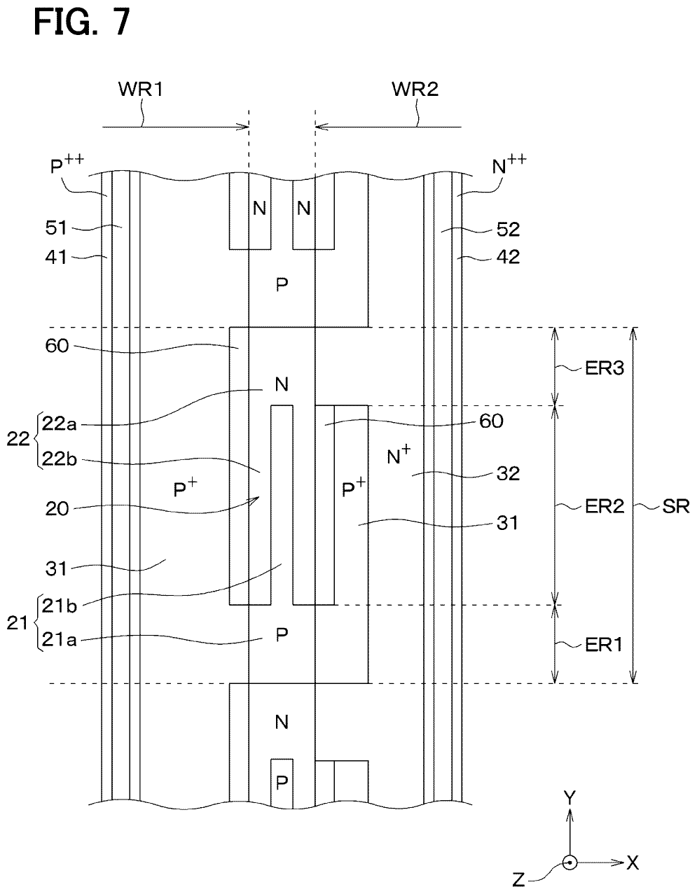

In the first embodiment, a P-type, an N-type, and a P-type are arranged in the X direction in the second extension region ER2 of the core portion 20. However, as shown in FIG. 7, the optical phase shifter may be configured such that an N-type, a P-type, and an N-type are arranged in the second extension region ER2. That is, in the first embodiment, the first convex portion 21, the first slab portion 31, and the first contact portion 41 may be P-type, and the second convex portion 22, the second slab portion 32, and the second contact portion 42 may be N-type. In other words, the first convex portion 21, the first slab portion 31, and the first contact portion 41 in the first embodiment may be interchanged with the second convex portion 22, the second slab portion 32, and the second contact portion 42. In this configuration, a higher voltage than that applied to the first contact portion 41 may be applied to the second contact portion 42. In this configuration, the P-type is a first conductivity type, and the N-type is a second conductivity type.

### Second Embodiment

A second embodiment is described. In this embodiment, the number of PN junctions in the second extension region ER2 is increased compared to the first embodiment. The remaining configurations are similar to those of the first embodiment and will thus not be described repeatedly.

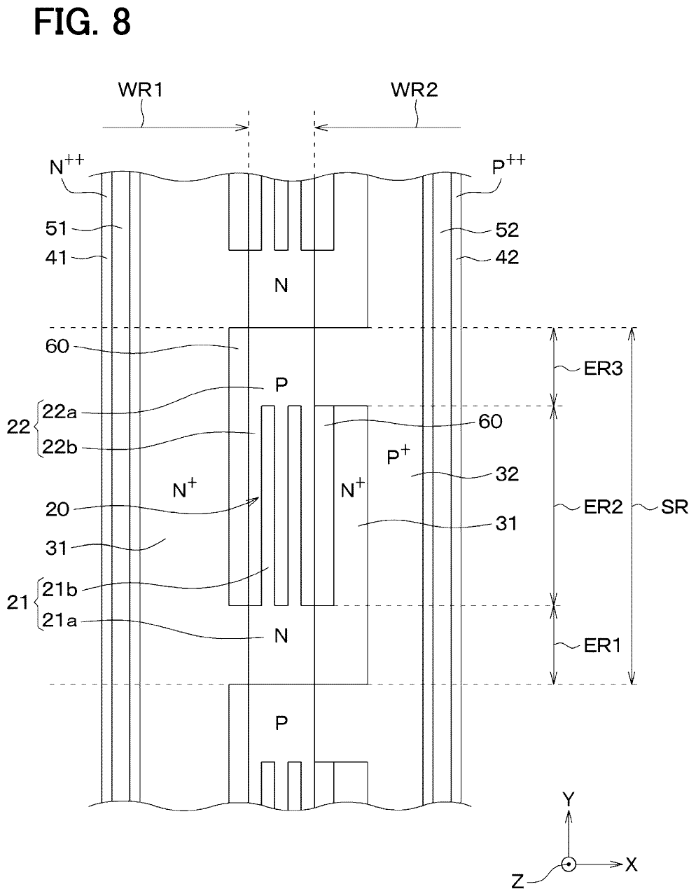

As shown in FIG. 8, in the optical phase shifter of this embodiment, the first convex portion 21 has the width portion 21a and two extension portions 21b extending from the width portion 21a along the Y direction. The two extension portions 21b are disposed apart from each other in the X direction.

The second convex portion 22 has the width portion 22a and three extension portions 22b extending from the width portion 22a along the Y direction. The three extension portions 22b are disposed apart from each other in the X direction.

The first convex portion 21 and the second convex portion 22 are arranged such that the two extension portions 21b and the three extension portions 22b mesh with each other. As a result, in the core portion 20 of the second extension region ER2, a P-type, an N-type, a P-type, an N-type, and a P-type are arranged in the X direction. Compared to the first embodiment, the number of PN junctions increases, resulting in an increase in the number of depletion layers. Therefore, the modulation efficiency can be improved.

In this embodiment, the number of the extension portions 21b of the first convex portion 21 and the extension portions 22b of the second convex portion 22 can be changed as appropriate. However, if the number of PN junctions is increased too much, the depletion layers may be connected when a reverse bias voltage is applied, resulting in a decrease in the amount of phase modulation. For this reason, it is preferable that the number of PN junctions formed inside the core portion 20 is set so that the depletion layers are not in contact with each other when a reverse bias voltage is applied. For example, when the width of the core portion 20 is about 500 nm, it is preferable that four PN junctions (that is, depletion layers) are formed inside the core portion 20 as in this embodiment.

According to the present embodiment, in the second extension region ER 2 where a PN junction is formed between the core portion 20 and the slab portion 31, 32, the core portion 20 is interposed between the first slab portions 31. Therefore, effects similar to those of the first embodiment can be obtained.

(1) In this embodiment, the second extension region ER2 includes plural first convex portions 21 interposed between the second convex portions 22. This makes it possible to increase the number of PN junctions and improve the modulation efficiency. However, in such a configuration, it is preferable that the number of PN junctions formed inside the core portion 20 is set to such that the depletion layers are not in contact with each other when a reverse bias voltage is applied.

### Third Embodiment

A third embodiment will be described. In this embodiment, the configuration of the core portion 20 is changed from that of the first embodiment. The remaining configurations are similar to those of the first embodiment and will thus not be described repeatedly.

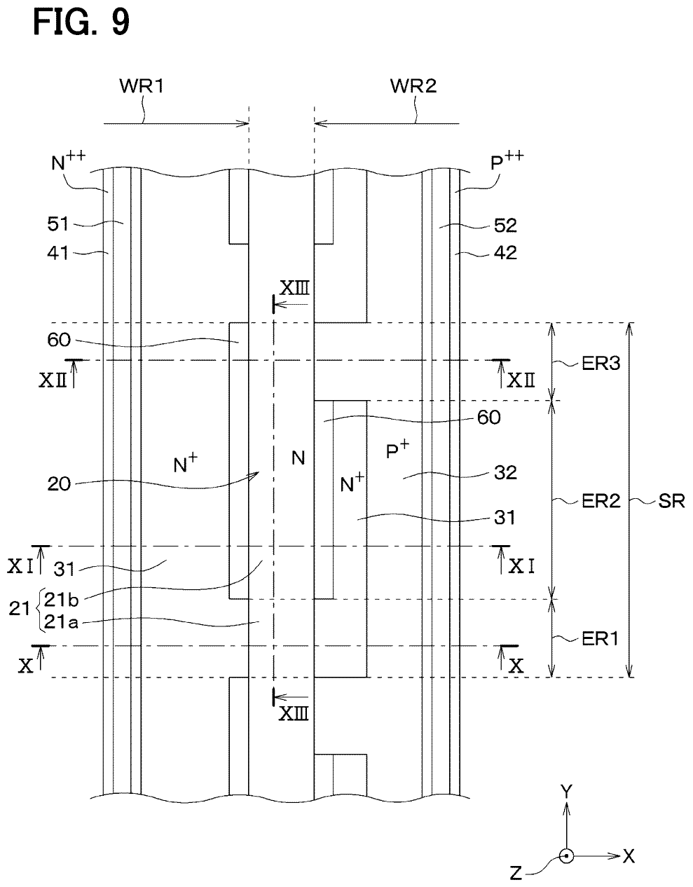

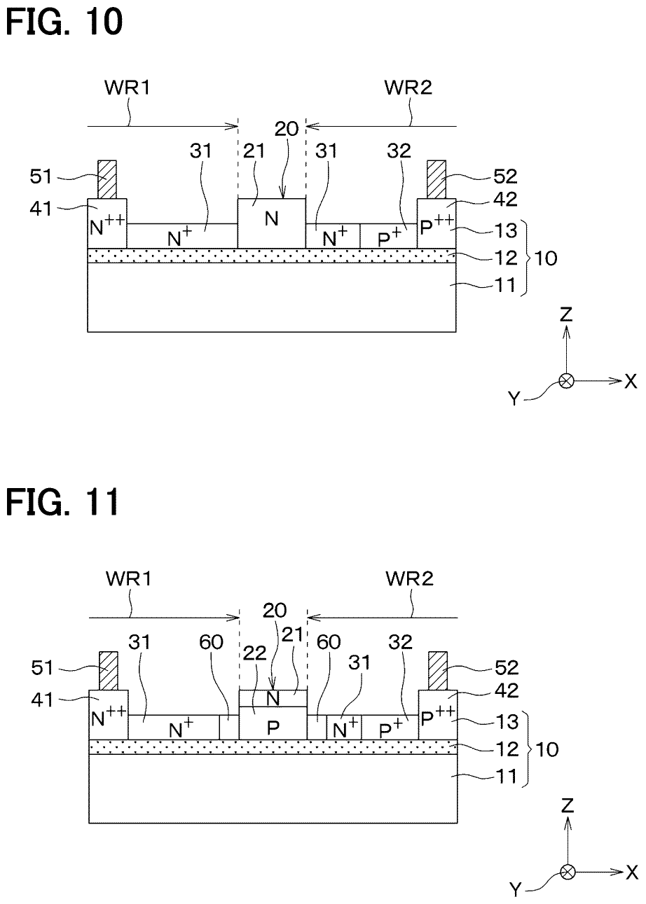

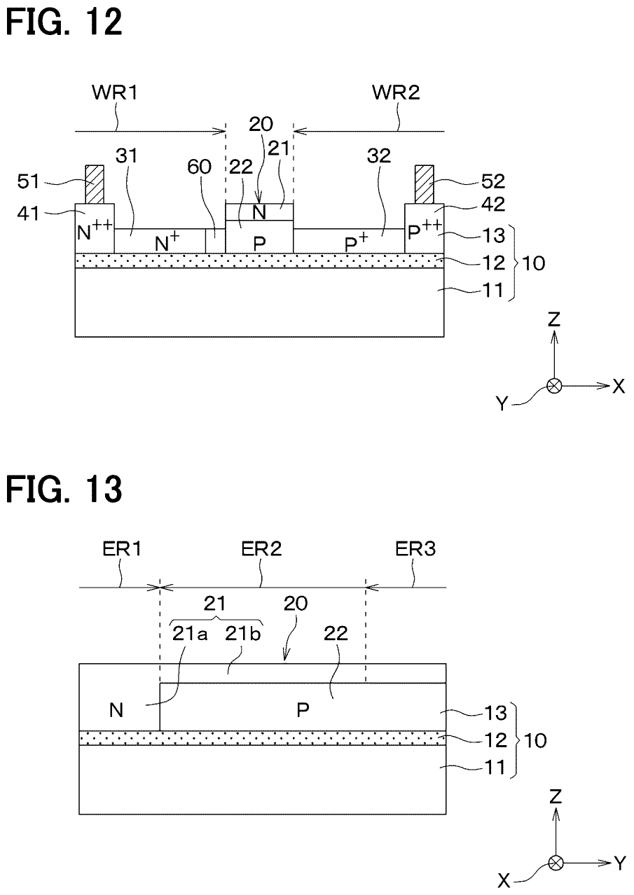

As shown in FIGS. 9 to 13, in the optical phase shifter of this embodiment, the core portion 20 is formed so that a PN junction is formed in the Z direction. FIG. 13 corresponds to a cross-section taken along line XIII-XIII in FIG. 9, and shows the core portion 20 of one cell region SR.

Specifically, the first convex portion 21 in this embodiment has the width portion 21a and the extension portion 21b that is thinner than the width portion 21a and extends in the Y direction. The width of the extension portion 21b is the same as that of the width portion 21a, and is configured to be thinner from the insulating layer 12.

The second convex portion 22 has the same width as the core portion 20, and has a thickness corresponding to the thinned portion of the extension portion 21b of the first convex portion 21.

The first convex portion 21 and the second convex portion 22 are arranged so as to form a PN junction in the Z direction (i.e., the XY plane). In this embodiment, a region in the X direction in which only the first convex portion 21 is arranged as the core portion 20 is defined as a first extension region ER1. In this embodiment, a region in which the first convex portion 21 and the second convex portion 22 are arranged as the core portion 20 interposed between the first slab portions 31 is defined as the second extension region ER2. In this embodiment, a region in which the first convex portion 21 and the second convex portion 22 are arranged as the core portion 20 and the second convex portion 22 is connected to the second slab portion 32 is referred to as the third extension region ER3. The first convex portion 21 and the second convex portion 22 are arranged such that a PN junction is formed in the second extension region ER2 and the third extension region ER3.

The first slab portion 31 and the second slab portion 32 are arranged in the same manner as in the first embodiment. Therefore, in the second extension region ER2, the N-type first slab portion 31 is arranged in the first width region WR1 and the second width region WR2 so as to form a PN junction with the P-type second convex portion 22. That is, in the second extension region ER2, the core portion 20 is interposed between the first slab portions 31 of the same conductivity type. In the third extension region ER3, the N-type first slab portion 31 is disposed in the first width region WR1 so as to form a PN junction with the P-type second convex portion 22. In the third extension region ER3, the P-type second slab portion 32 is disposed so as to be connected to the P-type second convex portion 22. However, the first slab portion 31 and the second slab portion 32 are made to have a thickness equal to or less than that of the second convex portion 22 arranged in the lower layer of the core portion 20.

In such an optical phase shifter, in the second extension region ER2, a PN junction is formed between the second convex portion 22 and the first slab portion 31 of the first width region WR1, and between the second convex portion 22 and the first slab portion 31 of the second width region WR2. In the second extension region ER2, a PN junction is formed between the extension portion 21b of the first convex portion 21 and the second convex portion 22. In the third extension region ER3, a PN junction is formed between the second convex portion 22 and the first slab portion 31 of the first width region WR1. In the third extension region ER3, a PN junction is formed between the extension portion 21b of the first convex portion 21 and the second convex portion 22. Therefore, similarly to the first embodiment, the phase of light can be modulated by applying a reverse bias voltage.

Furthermore, in an optical phase shifter of this embodiment, when the first slab portion 31 and the second slab portion 32 are formed by ion implantation, there is a possibility that the first slab portion 31 and the second slab portion 32 may be misaligned in the X direction due to mask misalignment, and the like. However, in this embodiment, as in the first embodiment, in the second extension region ER2, the core portion 20 (i.e., the second convex portion 22) is interposed between the first slab portions 31. Therefore, when the first slab portion 31 and the second slab portion 32 are misaligned in the X direction, the misalignment can be easily offset, and a large change in the modulation efficiency can be suppressed.

According to the present embodiment, in the second extension region ER 2 where a PN junction is formed between the core portion 20 and the slab portion 31, 32, the core portion 20 is interposed between the first slab portions 31. Therefore, effects similar to those of the first embodiment can be obtained.

(1) In this embodiment, a PN junction is formed in the portion where the first convex portion 21 is stacked on the second convex portion 22, and the PN junction is formed in a direction along the XY plane. The core portion 20 is usually configured so that its width is longer than its thickness. Light tends to spread in the X direction. Therefore, by forming a PN junction in a direction along the XY plane, it is possible to easily improve the modulation efficiency.

### Other Embodiments

Although the present disclosure has been described in accordance with the embodiments, it is understood that the present disclosure is not limited to such embodiments or structures. The present disclosure encompasses various modifications and variations within the scope of equivalents. In addition, various combinations and modes, and other combinations and modes including only one element, more elements, or less elements are also within the scope and idea of the present disclosure.

For example, in each of the embodiments, the optical phase shifter may be configured with one cell region SR.

In each of the embodiments, the first convex portion 21 and the second convex portion 22 may have different impurity concentrations.

In each of the embodiments, when the misalignment is zero, the core portion 20 may be in contact with the first slab portion 31 and the second slab portion 32. However, as described in the first embodiment, if misalignment causes the first slab portion 31 or the second slab portion 32 to reach the inside of the core portion 20, the loss of light becomes large. For this reason, it is preferable that the non-doped layer 60 is disposed when the misalignment is zero so that the first slab portion 31 or the second slab portion 32 does not reach the inside of the core portion 20 even if misalignment occurs.

In the second and third embodiments, similar to the modification of the first embodiment, the first convex portion 21, the first slab portion 31, and the first contact portion 41 may be the P-type, and the second convex portion 22, the second slab portion 32, and the second contact portion 42 may be the N-type.

What is claimed is:

1. An optical phase shifter comprising:
a core portion extending in an extending direction and having a thickness direction intersecting with the extending direction; and
a slab portion arranged on sides of the core portion, a length of the slab portion in the thickness direction being shorter than that of the core portion, wherein
the core portion has a first convex portion of a first conductivity type and a second convex portion of a second conductivity type,
the slab portion has a first slab portion of a first conductivity type and a second slab portion of a second conductivity type,
the first slab portion is electrically connected to the first convex portion, and the second slab portion is electrically connected to the second convex portion,
the first convex portion and the second convex portion are arranged to form a PN junction,
the slab portion is made of an ion implantation layer, and is located to include a portion that forms the PN junction with the core portion, the PN junction being formed between the slab portion and the core portion within a predetermined region,
the second convex portion is arranged on both sides of the core portion adjacent to the slab portion within the predetermined region, and
the first slab portion is arranged on sides of the core portion within the predetermined region.

2. The optical phase shifter according to claim 1, wherein the second convex portion is arranged on sides of the first convex portion in a width direction intersecting the extending direction and the thickness direction within the predetermined region.

3. The optical phase shifter according to claim 2, wherein
the core portion has a plurality of sets in which the second convex portion is arranged on sides of the first convex portion in the width direction, and is configured such that depletion layers resulting from the PN junction between the first convex portion and the second convex portion are non-contact with each other.

4. The optical phase shifter according to claim 1, wherein the first convex portion is disposed on an upper side of the second convex portion within the predetermined region where the PN junction is formed between the slab portion and the core portion.

5. The optical phase shifter according to claim 1, wherein the predetermined region in which the PN junction is formed between the slab portion and the core portion is repeatedly arranged in the extending direction.
